(19) United States
(12) Patent Application Publication
(10) Pub. No.: US 2006/0201330 A1
(43) Pub. Date: Sep. 14, 2006

(54) Combined beverage container and horn assembly

(76) Inventor: Wayne Cohen, Bangkok (TH)

Correspondence Address: DORSEY & WHITNEY LLP;INTELLECTUAL PROPERTY DEPARTMENT, 250 PARK AVENUE, NEW YORK, NY, 10177, US

(21) Appl. No.: 11/375,637

(22) Filed: Mar. 13, 2006

Related U.S. Application Data
(60) Provisional application No. 60/660,588, filed on Mar. 11, 2005.

(51) Int. Cl. A23L 1/00

(52) U.S. Cl. 99/275

(57) ABSTRACT

A combined beverage container and horn assembly is provided. The combined beverage container and horn assembly may be easily assembled and disassembled for configuration either as a horn assembly or a beverage container. The combined beverage container and horn assembly can include a first arrangement, a second arrangement, and a third arrangement. The first arrangement may have a sound generating assembly. The second arrangement can be adapted to provide sound therethrough and/or to be used as a beverage container. The third arrangement may provide a base for supporting the second arrangement. The first and third arrangements may be provided with a threaded coupling on an interior portion thereof while the second arrangement may be provided with a complementary threaded coupling on an exterior portion thereof. The second arrangement thus may be alternately coupled to the first arrangement for use as a horn or to the third arrangement for use as a beverage container.

### CROSS-REFERENCE TO RELATED APPLICATION(S)

The present application claims priority to U.S. Application No. 60/660,588 filed on Mar. 11, 2005, and relates to U.S. Application No. 60/644,047 (filed Jan. 13, 2005) and Ser. No. 11/330,012 (filed Jan. 10, 2006), all of which are incorporated herein by reference.

### FIELD OF THE INVENTION

The present invention relates generally to horn assemblies, and more specifically to a combined beverage container and horn assembly.

### BACKGROUND INFORMATION

During a variety of events, such as sporting events, it may be desirable for patrons to generate noise. For example, during a football game, fans may generate noise to indicate their approval or disapproval of occurrences in play actions, and/or to generally show support for their team. At a football game, fans typically generate noise in an effort either to urge on the team one wishes to support or to distract the opposing team.

In creating noise, fans often clap their hands, stamp their feet, or use their voices to shout or yell. In certain situations, fans roll programs to produce a makeshift horn. Thus, at such spectator events, one may see spectators forming their programs into a horn shaped configuration to more fully project sound.

The use of a membrane in conjunction with air to generate sound is known. High acoustic output horns producing tonal sounds are thus produced for use by sports fans or other individuals, such that sounds may be generated by blowing through a hole of the horn.

During many events, patrons further consume beverages. It has become increasingly popular to provide beverage containers that may be taken home as souvenirs of the event. Typically the souvenir beverage container is a plastic beverage container designed with a graphic related to the event.

However, there remains a need for providing a lightweight, inexpensive horn that takes little space but which may be assembled to be able to produce a loud, clear tone, for use, for example, in a sports stadium. There further remains a need for providing a beverage container that has souvenir value, and may be used as a horn after or before its use as a beverage container.

### SUMMARY OF EXEMPLARY EMBODIMENT(S) OF THE INVENTION

A combined beverage container and horn assembly is provided. The combined beverage container and horn assembly may be assembled and disassembled for configuration either as a horn assembly and/or a beverage container.

The combined beverage container and horn assembly can include a first arrangement, a second arrangement, and a third arrangement. The first arrangement may have a sound generating assembly. The second arrangement can be adapted to provide sound therethrough and/or to be used as a beverage container. The third arrangement may provide a base for supporting the second arrangement. The first and third arrangements may be provided with a threaded coupling on an interior portion thereof while the second arrangement may be provided with a complementary threaded coupling on an exterior portion thereof. The second arrangement thus may be alternately coupled to the first arrangement for use as a horn or to the third arrangement for use as a beverage container.

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a first right side cross-sectional view of a combined beverage container and horn assembly in accordance with a first exemplary embodiment of the present invention;

FIG. 2 is a second right side view of the combined beverage container and horn assembly of FIG. 1;

FIG. 3 is a back end view of the combined beverage container and horn assembly of FIG. 1;

FIG. 4 is a first left side view of the combined beverage container and horn assembly of FIG. 1;

FIG. 5 is a second left side cross-sectional view of the combined beverage container and horn assembly of FIG. 1;

FIG. 6 is a front end view of the combined beverage container and horn assembly of FIG. 1;

FIG. 7 is a rear perspective view of the combined beverage container and horn assembly of FIG. 1;

FIG. 8 is a front perspective view of the combined beverage container and horn assembly of FIG. 1;

FIG. 9 is a top perspective view of a combined beverage container and horn assembly in a beverage container configuration;

FIG. 10 is a side cross-sectional view of the combined beverage container and horn assembly of FIG. 9; and

FIG. 11 is a side-view of the combined beverage container and horn assembly of FIG. 9.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION

An exemplary embodiment of a combined container and horn assembly comprises a first arrangement (e.g., a mouthpiece arrangement) and a second arrangement (e.g., a sound making arrangement). The second arrangement may comprise a beverage container, and/or can be interchangeable with the beverage container.

The exemplary embodiment of the combined beverage container and horn assembly may be used at sporting events, where sound making can be combined with the enjoyment of beverages (e.g., beer, soda, juice, etc.). In addition, it is possible to make this exemplary assembly available to children at various food dispensing establishments.

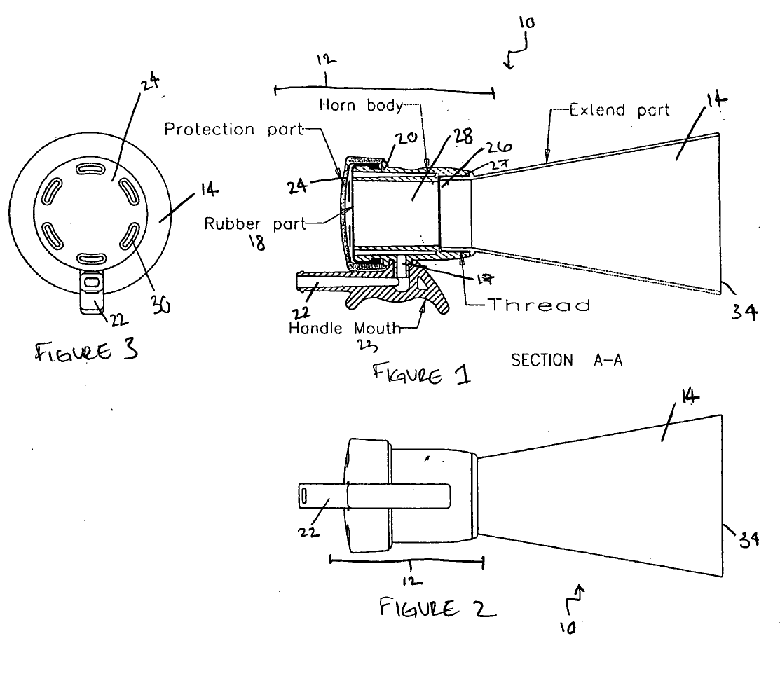

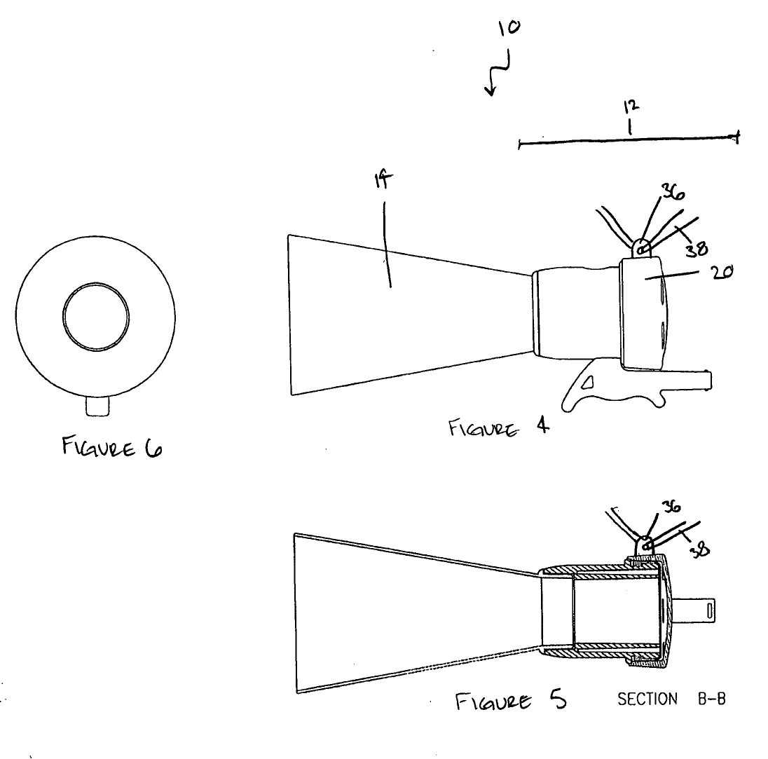

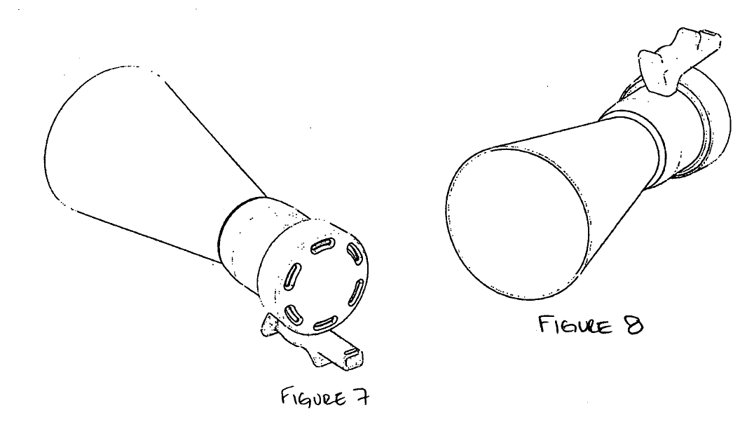

FIGS. 1-8 illustrate a single-horn combined beverage container and horn assemblies according to exemplary embodiments of the present invention. FIGS. 1 and 3 illustrate cross-sectional views of one exemplary embodiment of the assembled combined beverage container and horn assembly. FIG. 2 illustrates an exploded perspective view of the exemplary assembly of FIGS. 1 and 3. FIGS. 7 and 8 illustrate perspective views of various exemplary embodiments of the single-horn combined beverage container and horn assemblies according to the present invention which includes a mouthpiece and a horn.

As shown in these figures, each exemplary combined beverage container and horn arrangement 10 includes a first arrangement 12 and a second arrangement 14. The second arrangement 14 is coupled to the first arrangement 12. The coupling may be temporary or permanent, and may be done in any suitable manner. For example, the coupling may be via a pressure fitting, via a threaded arrangement, via an adhesive, and/or in any other suitable manner.

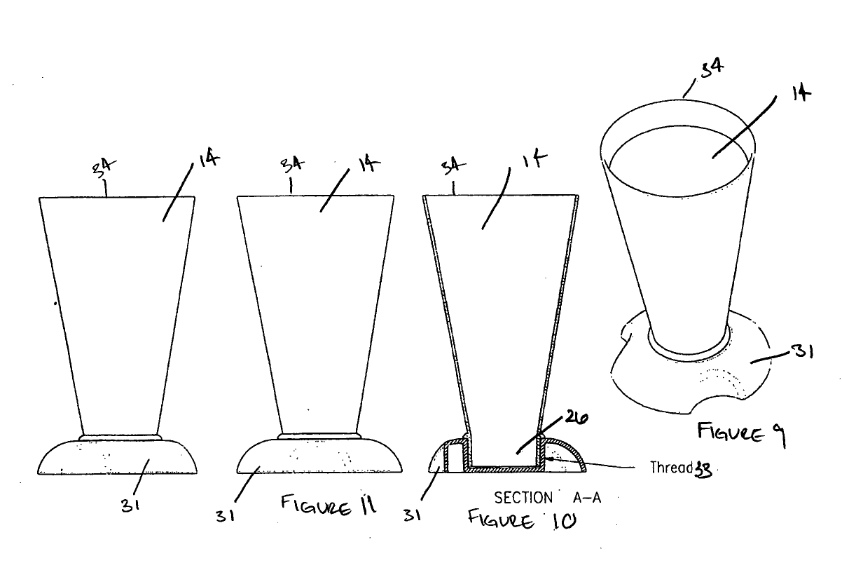

In one exemplary embodiment, the coupling can be provided via a threaded arrangement, whereas threads are provided on an external surface of the second arrangement 14, and complementary threads can be provided on an internal surface of the first arrangement 12. A third arrangement 31, or beverage support arrangement, shown in FIGS. 9-11, is provided with similar complementary threads on an internal surface.

The exemplary first arrangement 12 can include a sound generating assembly. In the exemplary embodiment shown in FIGS. 1-8, the sound generating assembly includes an elastic membrane/rubber portion or diaphragm 18, a base structure 20 and an inlet tube 22. A handle 23 may be provided with the inlet tube 22. The handle 23 may be ergonomically formed for better gripping by a user. A membrane cover or protection part 24 may further be provided with the first arrangement 12.

The diaphragm 18 can be located at the input or a reduced diameter end 26 of the combined beverage container and horn assembly 10 when assembled, as shown in FIG. 1. The diaphragm 18 may be manufactured of any suitable material. For example, the diaphragm 18 may be manufactured of rubber, silicone, latex, vinyl, mylar, and/or other material. Vibrations of the diaphragm 18 can be induced by air flow generated between the membrane 18 and an adjacent housing 28 in the base structure 20. The diaphragm 18, in combination with the housing 28, may form a substantially sealed chamber. The sealed chamber can provide rebounding compression against the diaphragm 18 as the diaphragm 18 is forced or expended into the chamber by the air flow. By placing one's mouth on the tube 22 and blowing there through, air flows past the membrane 18 and out of the second arrangement 14. The combined beverage container and horn assembly 10 is thus configured to provide a sound. Another way of sounding the horn assembly may be provided. For example, a compressed air source (as known to those skilled in the art) may be coupled to the first arrangement for generating air flow at or past the diaphragm 18.

A diaphragm cover 24 may be provided for the horn assembly 10 to protect the diaphragm 18. The membrane cover 24 may be provided for user replacement of the diaphragm 18 and/or situated on the first arrangement 12. Air vents 30 (as shown in FIG. 3) are provided on the membrane cover 24 such that air may pass externally of the first arrangement 12 to the membrane 18. The air vents 30 may be customized, for example, as a mascot or a logo.

An inlet tube 22 may be provided for blowing air across the diaphragm 18. In one exemplary embodiment of the present invention, the base structure 20 can be provided with an extension 17 for receipt by the inlet tube 22, as shown in FIG. 1. The placement of the extension 17 in the inlet tube 22 can operate to couple the inlet tube 22 to the base structure 20, and thereby to the combined beverage container and horn assembly 10. Alternately, any suitable manner of coupling the inlet tube 22 to the combined beverage container and horn assembly 10 may be implemented. Any suitable material may be used for manufacturing the inlet tube 22. For example, a rigid plastic such as high impact styrene may be used. Alternately, a soft material with, for example, a rubber-like feel may be used. In some exemplary embodiments, a soft material may be advantageous for use so as to reduce the likelihood of injury to the user's face or teeth. As stated above, alternate ways for generating air flow across the diaphragm 18 may be used instead of or in addition to the use of the inlet tube 22.

A lanyard holder 36 may also be provided, as shown in FIGS. 4 and 5. As shown in FIGS. 4 and 5, the lanyard holder 36 may be integral with the base structure 20. Alternately, the lanyard holder 36 may be provided in an alternate location on the combined beverage container and horn assembly 10. A lanyard 38 may be inserted through the lanyard holder 36, and the combined beverage container and horn assembly 10 may be worn around a user's neck.

As indicated herein above. the first arrangement 12 can be coupled to the second arrangement 14. The coupling may be temporary or permanent and may be via any suitable means. A detachable connection may be provided via a threaded inner section of the second arrangement working as a “screw-on” connection with the first arrangement. It should be understood that other detachable (or permanent) connections between the first arrangement 12 and the second arrangement 14 are possible, and are within the scope of the present invention.

In the exemplary embodiments shown in the figures, the second arrangement 14 comprises a mouthpiece and/or beverage container. More specifically, the second arrangement 14 may comprise an arrangement that may be used as a beverage container and may be used as a mouthpiece before or after use as a beverage container. The second arrangement generally may be provided in a frustoconical form. A logo or design may be provided on the second arrangement 14 such that, for example, a sponsor may advertise on the combined beverage container and horn assembly 10. Similarly, indicia provided on the second arrangement 14 may enhance the souvenir characteristics of the second arrangement 14. The second arrangement 14 may be formed of any suitable material for use as a beverage container and a mouthpiece, such as, for example, paper with plastic lamination, paper with wax covering, plastic sheet material, or other.

The second arrangement 14 may be formed of a sheet of such material, the sheet of material having first and second side edges. The sheet may be configured for rolling with the first and second side edges overlapping so as to form, e.g., a frustoconical shape. The second arrangement 14 may be secured in this position in any suitable manner. Thus, for example, the first and second edges of the sheet of the second arrangement 14 may be formed with suitable interlocking edge configurations. For example, edge arms may be provided on the first edge with edge slots for receiving the edge arms on the second edge. In alternate exemplary embodiments, the edges may be secured using an adhesive. In further exemplary embodiments, the edges may be heat sealed. In yet further exemplary embodiments, the second arrangement 14 may be provided as a single extruded or molded component.

The second arrangement 14 may be provided to patrons in the frustoconical configuration such that the second arrangement is suitable for use as a beverage container. A beverage container support arrangement 31, shown in FIGS. 9-11 and described below, may be provided. In the frustoconical configuration, the second arrangement 14 has a relatively narrow coupling end 26, and expands outwardly, terminating in a sound transmitting end 34 of larger dimensions than the coupling end 26. The sound transmitting end 34 is the drinking end of the beverage container. The dimensions of the second arrangement 14 may be modified for any reason, and possibly to alter the pitch of the horn assembly 10. Thus, for example, the second arrangement 14 that is slightly shorter in the axial direction may have an increased pitch.

The second arrangement 14 may be provided as a flat sheet or preassembled into a frustoconical configuration. For example, it may be desirable to minimize shipping and storage space. Thus, the second arrangements 14 may be shipped as flat sheets. In other examples, it may be desirable to ship the second arrangements 14 in stacks of preassembled horns/beverage containers.

To assemble the combined beverage container and horn assembly 10, the first arrangement 12 can be coupled to the coupling end 26 of the second arrangement 14. The attachment of the first arrangement 12 to the second arrangement 14 may be performed using a releasable coupling or a permanent coupling. A threading may be provided on the outside of the coupling end 26 of the second arrangement 14. A complimentary threading may be provided on the inside of the coupling portion 27 of the first arrangement 12. The coupling end 26 of the second arrangement may be inserted and threaded into the complimentary threads of the coupling portion 27 of the first arrangement 12.

The quality of sound in a horn assembly 10 may be effected by leaks through which air could escape from the column or shape of the second arrangement 14. Thus, it may be useful to form an airtight junction between the second arrangement 14 and the first arrangement 12 of the horn assembly 10.

In the exemplary embodiment shown in the figures, the horn assembly 10 can be sounded by blowing through the inlet tube 22 to provide a stream of air past the diaphragm 18 and through the second arrangement 14. Again, alternate ways of providing air flow past the diaphragm 18 may be provided.

A third arrangement 31 may be provided as a beverage container base. The third arrangement may be configured with threads on an interior surface of a coupling portion 33, as shown in FIG. 10, the threads being complementary to the threads of the coupling end 26 of the second arrangement 14. The coupling end 26 of the second arrangement 14 may be inserted and threaded into the complimentary threads of the coupling portion 33 of the third arrangement 31, as shown in FIG. 9. In the exemplary embodiment shown in FIGS. 9-11, the diameter of the third arrangement 31 approximates the diameter of the sound transmitting or drinking end 34 of the second arrangement 14. This permits for stable standing of the beverage container when the second arrangement 14 and the third arrangement 31 are coupled to one another. In alternate exemplary embodiments, the diameter of the third arrangement 31 may approximate the diameter of the coupling end 26 of the second arrangement 14. The third arrangement 31 may alternately be provided in any suitable size.

It is possible to permit leakage from the second arrangement 14 when the second arrangement 14 is coupled to the third arrangement 31. Thus, it may be useful to form a fluid-tight junction between the second arrangement 14 and the third arrangement 31.

The exemplary embodiments of the present invention thus provide an easily assembled, lightweight and relatively inexpensive combined beverage container and horn assembly. The exemplary combined beverage container and horn assembly is customizable with any of the first arrangement, second arrangement, or third arrangement being customizable. Thus, for example, a supplier may stock generic first and third arrangements (preassembled or in parts), and print or manufacture customized second arrangements for specific events.

In one exemplary embodiment of the present invention, for transport and storage purposes, the combined beverage container and horn assembly may be provided with the second arrangements preassembled and stacked in frustoconical configuration and with the first and third arrangements provided separately, whereas the user may couple either the first or the third arrangement to the second arrangement depending on the desired use. For example, if the user initially desires to drink a beverage, the user may couple the second arrangement to the third arrangement. If the user initially desires to cheer or make noise, the user may couple the second arrangement to the first arrangement.

As will be appreciated, the first and third arrangements may be coupled to guard against loss of any one of the first, second and/or third arrangements. For example, a lanyard holder may be provided on the third arrangement in addition to the lanyard holder 36 on the first arrangement. A lanyard 38 may then be extended through each of the lanyard holders of the first and the third arrangements.

It should be understood that there can be various shapes and configurations of the combined beverage container/horn arrangement. For example, the shape and configuration of the second arrangement (or horn part) can be modified in accordance with the requests of customers, e.g., the size requirements can vary, the preference to have a higher pitch or a lower pitch. It is also within the scope of the present invention to at least approximately match the design and portions of the shape of the third arrangement (or beverage container portion) with that of the horn portion.

While the invention has been described in connecting with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

What is claimed is:

1. A combined beverage container and horn assembly comprising:
a first arrangement including a sound generating assembly;
a second arrangement adapted to provide sound therethrough; and
a third arrangement,
wherein the second arrangement is configured for coupling to at least one of the first arrangement or the third arrangement,
wherein, when the second arrangement is coupled to the first arrangement, the assembly is capable of enhancing a sound being generated by the first arrangement, and
wherein, when the second arrangement is coupled to the third arrangement, the assembly is suitable for use as a beverage container.

2. The horn assembly of claim 1, wherein the first arrangement comprises a membrane and an inlet tube, wherein the inlet tube leading to the membrane.

3. The horn assembly of claim 2, wherein the first arrangement further comprises a base assembly supporting the membrane and the inlet tube.

4. The horn assembly of claim 2, wherein the first arrangement further comprises a membrane cover to be placed over the membrane.

5. The horn assembly of claim 4, wherein the membrane cover includes air vents.

6. The horn assembly of claim 5, wherein the air vents are provided in a customizable configuration.

7. The horn assembly of claim 2, wherein, when the second arrangement is coupled to the third arrangement by blowing through the inlet tube, the sound is generated.

8. The horn assembly of claim 1, wherein the first arrangement and the third arrangement each comprise a threaded coupling on an interior portion thereof and wherein the second arrangement comprises a complementary threaded coupling on an exterior thereof.

9. The horn assembly of claim 1, wherein the first arrangement comprises a lanyard holder.

10. The horn assembly of claim 9, wherein the third arrangement comprises a lanyard holder.
